(19) United States
(12) Patent Application Publication
(10) Pub. No.: US 2025/0086854 A1
(43) Pub. Date: Mar. 13, 2025

(54) PALETTE-BASED IMAGE MODELING AND GENERATION

(71) Applicant: Visual Electric Company, Sausalito, CA (US)

(72) Inventors: Adam Menges, Mill Valley, CA (US); Colin William Dunn, Larkspur, CA (US); Zachary Stiggelbout, Mill Valley, CA (US)

(21) Appl. No.: 18/830,428

(22) Filed: Sep. 10, 2024

Related U.S. Application Data
(60) Provisional application No. 63/639,543, filed on Apr. 26, 2024.
(60) Provisional application No. 63/582,141, filed on Sep. 12, 2023.

(51) Int. Cl. G06T 11/00

(52) U.S. Cl. CPC G06T 11/001

(57) ABSTRACT

A system leverages machine learning models to generate images, to customize and modify such images, and to generate additional images. The images can be generated within a digital canvas, allowing users to create sets of images, to compare such images, and to use such generated images to generate prompts and additional images. Tools can be provided to allow users to generate images with specific characteristics. For instance a color palette tool can allow users to specify particular colors and color shades for use in generating images. Likewise, a collage tool can allow users to generate and use a seed image to generate images for a collage of images. The system tracks states of images and other media content to promote user interaction with existing media content to generate new media content.

### CROSS-REFERENCE TO RELATED APPLICATIONS

This application claims the benefit of U.S. Provisional Application No. 63/582,141, filed Sep. 12, 2023, and U.S. Provisional Application No. 63/639,543, filed Apr. 26, 2024, each of which is incorporated by reference in their entirety for all purposes.

### BACKGROUND

### Technical Field

This disclosure relates generally to generating media content, and, more specifically, to generating media content at a user interface that tracks states of media content at the user interface and promotes user interaction with existing media content to generate new media content.

### Description of the Related Art

Conventional generative design systems are typically capable of providing media content (such as images) in response to instructions provided by a user. However, conventional generative design systems are generally limited by a “chat box” style interface or merely follow a user's immediate instructions without considering the user's previously generated media content. Interface constraints limit a user in flexibility to instruct the conventional generative design system and consequently, limits the conventional generative design system's ability to generate media content. Additionally, conventional generative design systems are less personalized because these systems output media content in an isolated fashion that does not consider a user's previously generated media content.

### SUMMARY

A generative design system generates an environment at a client device for users to generate media content and interact with the generated media content to subsequently generate more media content. Unlike a conventional generative design system that merely receives instructions and generates content in a fashion that isolates one generation from the next, the generative design system's environment is an infinite canvas that tracks all generated media content and allows users to build upon their previous creations. The generative design system thus enables a user's creativity to build upon itself, resembling a more natural creative process (e.g., using an actual canvas or whiteboard). When generating new media content, the generative design system can account for media content on the infinite canvas that were previously generated by the user. For example, the generative design system can perform outpainting based on images that are located within a threshold radius of an image targeted for outpainting. In another example, the generative design system can generate recommendations for editing images based on tracked states of images (e.g., how frequently a user has interacted with each image) displayed at the infinite canvas. In yet other examples, text prompt predictions can be used to help users generate new images, portions of images can be combined for use as a seed image in generating an image collage, and color palette tools can be used to generates images in selected colors and color shades. In these ways, the generative design system may provide tailored generative AI in a flexible space that promotes creation and creativity.

### BRIEF DESCRIPTIONS OF THE DRAWINGS

The patent or application file contains at least one drawing executed in color. Copies of this patent or patent application publication with color drawings will be provided by the Office upon request and payment of the necessary fee.

The disclosed embodiments have other advantages and features which will be more readily apparent from the following detailed description of the invention and the appended claims, when taken in conjunction with the accompanying drawings, in which:

Figure (or “FIG.”) 1 depicts a user interface for generating content on an infinite canvas, according to one embodiment.

FIG. 2 is a block diagram of an environment in which a generative design system operates, according to one embodiment.

FIG. 3 is a block diagram illustrating an embodiment of the generative design system.

FIG. 4 depicts a user interface for recommending media content design prompts based on images displayed on an infinite canvas, in accordance with one embodiment.

FIG. 5 depicts an example embodiment of a text prompt input including recommended prompts for designing media content.

FIG. 6 depicts an example embodiment of a text prompt input including recommended prompts for generating media content based on a sketch.

FIG. 7 depicts a user interface for modifying media content based on a user's sketch drawn on an infinite canvas, in accordance with one embodiment.

FIG. 8 depicts a user interface for modifying an image based on a sketch, in accordance with one embodiment.

FIG. 9 depicts a user interface for inpainting in an infinite canvas, in accordance with one embodiment.

FIG. 10 depicts an example embodiment of outpainting of an image, in accordance with one embodiment.

FIG. 11 depicts an example embodiment of content item remixing.

FIG. 12 depicts an example embodiment of content item collaging.

FIG. 13 depicts two example embodiments of sub-moods for content item generation or editing.

FIG. 14A depicts a text prompt suggestion interface suggesting a first set of text prompt additions, according to one embodiment.

FIG. 14B depicts the text prompt suggestion interface of FIG. 14A suggesting a second set of text prompt additions, according to one embodiment.

FIG. 15A depicts a text prompt interface with a color palette selection interface, according to one embodiment.

FIG. 15B depicts sets of images generated using the color palette selection interface of FIG. 15A, according to one embodiment.

FIG. 16 depicts a process for combining images and generating an image collage based on the combined image, according to one embodiment.

FIG. 17A depicts an interface for automatically creating a custom mood based on a set of seed images, according to one embodiment.

FIG. 17B depicts an interface illustrating characteristics and examples of the custom mood created using the interface of FIG. 17A, according to one embodiment.

FIG. 17C depicts an interface illustrating a set of images generated using a text prompt and the mood created in the embodiment of FIG. 17B.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described.

A generative design system generates an environment at a client device for users to generate media content and interact with the generated media content to subsequently generate more media content. The generative design system's environment is an infinite canvas that tracks all generated media content and allows users to build upon their previous creations. The generative design system thus enables a user's creativity to build upon itself, resembling a more natural creative process (e.g., using an actual canvas or whiteboard). In these ways, the generative design system may provide tailored generative AI in a flexible space that promotes creation and creativity.

The infinite canvas of the generative design system promotes user interactions with the media content and affords additional ways to generate media content. Media content may also be referred to as “a content item” or “content items.” An “infinite canvas” may be an interactive space on a media content application where a user may provide instructions to create, modify, or remove media content. Media content includes images, animations (e.g., GIFs), videos, or any suitable medium for the display of visual creations. Media content may be characterized by attributes such as content, or subject, represented, colors, shapes, frame rate, size, brightness, location (e.g., on a webpage), resolution, contrast, any suitable property of an image, or a combination thereof. A generative design system described herein may generate an infinite canvas for designing media content. The infinite canvas may serve as an interactive white board. Users may provide instructions to the generative design system to modify attributes of media content displayed at an infinite canvas (e.g., modifying the location of an image on the infinite canvas). Users can modify and move generated media content to create new media content at the infinite canvas.

FIG. 1 depicts a user interface 100 for generating content on an infinite canvas, according to one embodiment. The user interface 100 depicts an embodiment where a user of an infinite canvas can prompt a machine learning model to generate a first set 106 of content items (e.g., images) and use a natural language prompt to generate a second set 110 of content items (e.g., images) related to the first set 106. The content items generated and modified are listed for convenience as images, but the generative design system described herein may generate and modify a variety of content items not limited to images. Alternative embodiments of the user interfaces shown in FIGS. 1 and 4-11 may include additional or different components. Components of the user interfaces shown may be located differently in alternative embodiments.

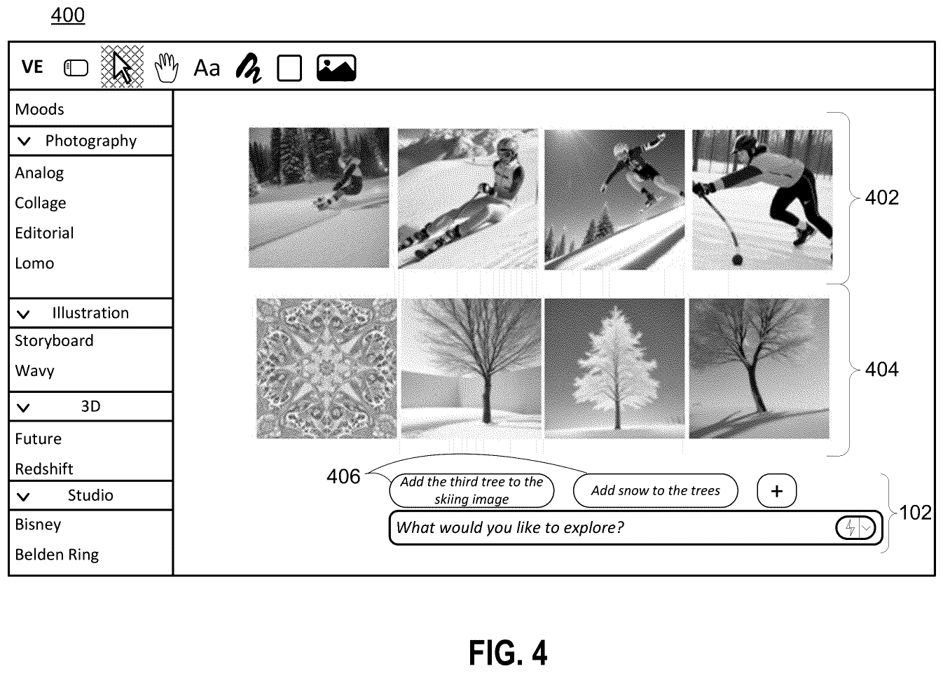

The user interface 100 includes a text prompt input 102, a content style menu 104, a tool menu 112, and an infinite canvas 114. The infinite canvas 114 includes artificial intelligence (AI) generated sets 106 and 110 of images. The text prompt input 102 may receive keywords, natural language prompts, selections of recommendations generated by the generative design system, any suitable instruction for generating media content, or a combination thereof. FIGS. 4-6 show additional embodiments of the text prompt input 102. The content style menu 104 provides a list of styles, or “moods,” that the generative design system may use to generate media content. Content style may be an attribute of media content. The content style menu 104 can include moods such as photography, illustration, three dimensional (3D), studio (e.g., film or videogame studio), any suitable genre of media content, or a combination thereof. One category of mood may have different subcategories of moods. For example, a photography mood may include analog, collage, editorial, and/or lomo. A user may select a mood and the generative design system may generate media content using a machine learning model trained using media content of that mood. For example, a user may select “Storyboard” illustration as a mood from the menu 104, provide a command such as “dogs playing in a park” into the text prompt input 102, and based on those user instructions, the generative design system may use a generative model (e.g., a Stable Diffusion™ model) to generate images of dogs playing in a park having a style similar to drawings created for storyboarding.

The tool menu 112 includes one or more selectable tools for using the infinite canvas 114. The tools may include the content style menu 104 (e.g., displaying or hiding the menu 104), a cursor for interacting with images (e.g., selecting, drag/drop, moving, resizing, etc.), a “grabber” hand for moving the infinite canvas 114 (e.g., to access images in different locations of the infinite canvas), a text box creator for adding text to the infinite canvas 114 (e.g., an image of editable text), a pen tool (e.g., to sketch objects or write text onto the infinite canvas 114), a shape generator (e.g., to create geometric shapes on the infinite canvas 114), an image uploader (e.g., to upload a user's image for display and/or modification at the infinite canvas 114), any suitable tool for creating or modifying media content at the infinite canvas 114, or a combination thereof.

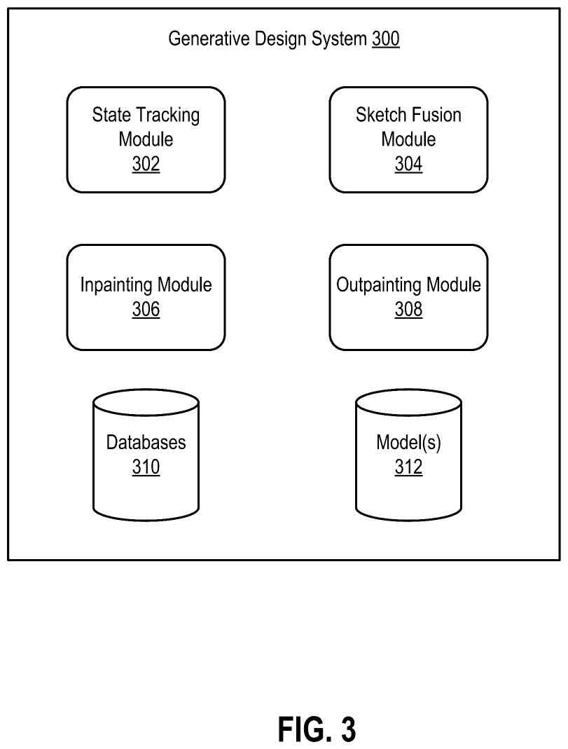

The infinite canvas 114 displays media content for interaction by a user of the generative design system. User interactions may include instructions to modify media content being displayed at the infinite canvas 114. The generative design system tracks states of media content at the infinite canvas 114. A state of media content may describe the media content's generation or display at an infinite canvas. States of the media content may include one or more labels indicating a time at which the content was generated, an order at which the content was generated (e.g., chronological order), which machine learning model(s) were used to generate the content, if and/or how a user modified the content, how the content was generated (e.g., with a sketch, user text prompt, or a suggested prompt generated by the generative design system), attributes of the media content (e.g., content, background, style of the content, style of the background, style of the overall media content, etc.), how a user interacts with the media content, etc. The generative design system is described with reference to FIG. 3.

In the embodiment depicted by the user interface 100, the generative design system generates images based on a previously generated set of images and additional user input. A user may provide instructions to the generative design system. For example, the user may type the keyword “park” into the text prompt input 102 and in response, the generative design system may use a generative model to create the first set 106 of images. The user may additionally specify a number of images to generate, a style with which to generate the images, a creative complexity (e.g., a degree of detail in the image), a size of an image, parameters associated with the generative model (e.g., sampling methods or schedulers, seeds, etc.), any suitable parameter for generating an image using AI, or a combination thereof. The generative design system may subsequently generate the second set 110 of images based on the first set 106 in response to the user selecting the image 108 and providing instructions using a natural language prompt of “add dogs to the park” in the input 102.

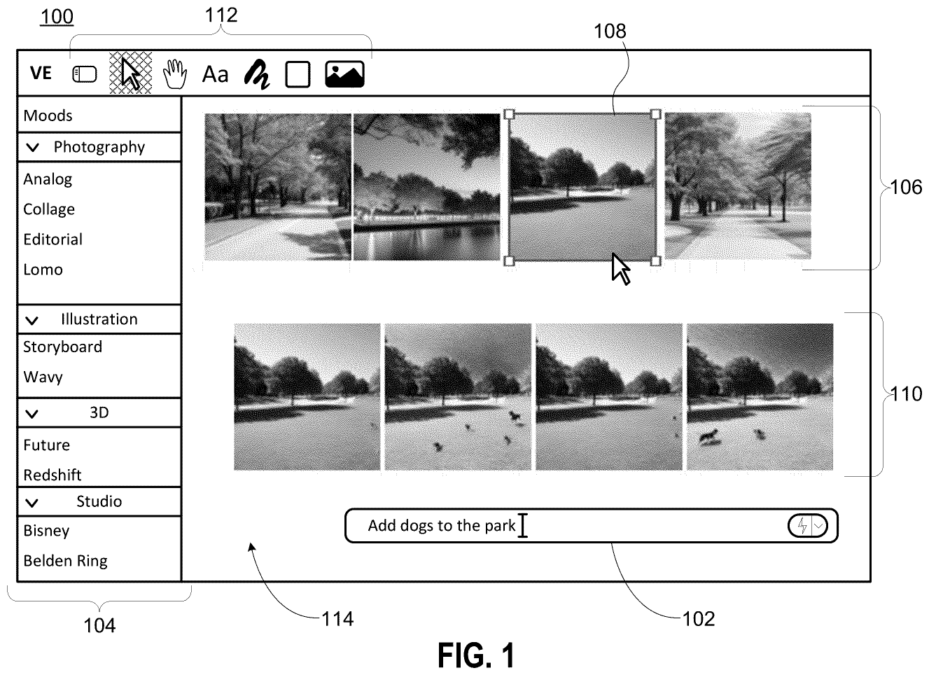

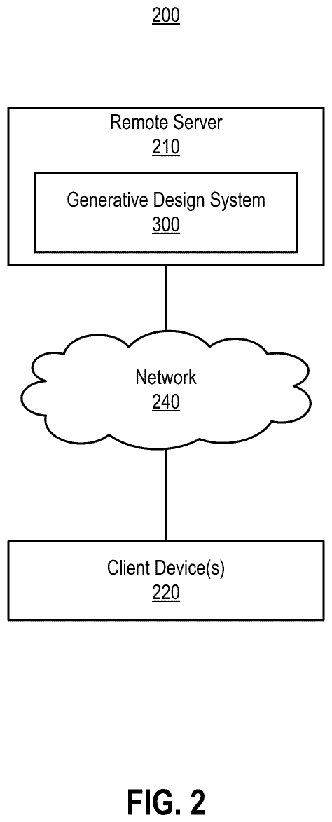

FIG. 2 is a block diagram of an environment 200 in which a generative design system 300 operates, according to one embodiment. The environment 200 includes a remote server 210, client device(s) 220, a network 240, and a generative design system 300 stored and executed at the remote server 210. In alternative configurations, different, additional, or fewer components may be in the environment 200. For example, the generative design system 300 may be stored and executed at the client device(s) 220.

The client device(s) 220 includes a computer device for processing and presenting media content such as audio, images, video, or a combination thereof. The client device(s) 220 may detect various inputs including voluntary user inputs (e.g., input via a controller, voice command, body movement, or other convention control mechanism). The client device(s) 220 can provide a user interface to enable the user to input information and interact with the generative design system 300. Examples of client device(s) 220 include a mobile device, tablet, laptop computer, desktop computer, gaming console, or other network-enabled computer device.

The remote server 210 may be one or more computing devices for generating a user interface for the generative design system 300 at the client device(s) 220 and/or delivering media content to the client device(s) 220 via the network 240. The remote server 210 may receive user instructions for interacting with the generative design system 300, where the user instructions are inputs received at the client device(s) 220. The generative design system 300 of the remote server 210 is described with respect to FIG. 3.

The network 240 may include any combination of local area or wide area networks, using both wired or wireless communication systems. In one embodiment, the network 240 uses standard communications technologies or protocols. In some embodiments, all or some of the communication links of the network 240 may be encrypted using any suitable technique.

Various components of the environment 200 of FIG. 2 such as the remote server 210, the network 240, and the client device(s) 220 can each include one or more processors and a non-transitory computer-readable storage medium storing instructions that, when executed, cause the one or more processors to carry out the functions attributed to the respective devices.

FIG. 3 is a block diagram illustrating an embodiment of the generative design system 300. The generative design system 300 may include a state tracking module 302, a sketch fusion module 304, an inpainting module 306, an outpainting module 308, databases 308, and model(s) 310. Alternative embodiments may include additional or different components. Although not depicted, the generative design system 300 may include modules for image generation and classification (e.g., image classification).

The state tracking module 302 tracks states of media content at an infinite canvas. Tracked states may be used to generate and/or edit media content at the infinite canvas. States of the media content may include one or more labels indicating a time at which the content was generated, an order at which the content was generated (e.g., chronological order), which machine learning model(s) were used to generate the content, if and/or how a user modified the content, how the content was generated (e.g., with a sketch, user text prompt, or a suggested prompt generated by the generative design system), a location of the content at the infinite canvas (e.g., coordinates or distance relative to other media content at the infinite canvas), a frequency with which a user has interacted with the media content (e.g., number of times clicked or modified), any suitable characteristic describing a given media content's generation or display at an infinite canvas, or a combination thereof. Other modules of the generative design system 300 may use the states tracked by the state tracking module 302 to generate and/or edit media content at the infinite canvas. For example, the inpainting module 306 can identify images at the infinite canvas based on the images' states (e.g., proximity to a target inpainting image) to generate new images.

The sketch fusion module 304 can modify media content based on a user's sketch drawn on an infinite canvas. A user may use a pen tool of the generative design system 300 to draw a sketch on the infinite canvas. The user may generate a first set of images using one or more generative models of the generative design system 300. The user may use the cursor tool to drag the sketch into one of the images of the first set of images and in response, the sketch fusion module 304 can create a second set of images that combine the sketch and the image into which it was dropped. The sketch fusion module 304 can determine the second set of images by identifying one or more objects of the sketch and using at least the identified one or more objects to generate the second set of images. The sketch fusion module 304 can use a machine learning model to identify one or more objects in a user's sketch. The sketch fusion module 304 may modify (e.g., augment) the instructions used to generate the first set of images using the one or more identified objects.

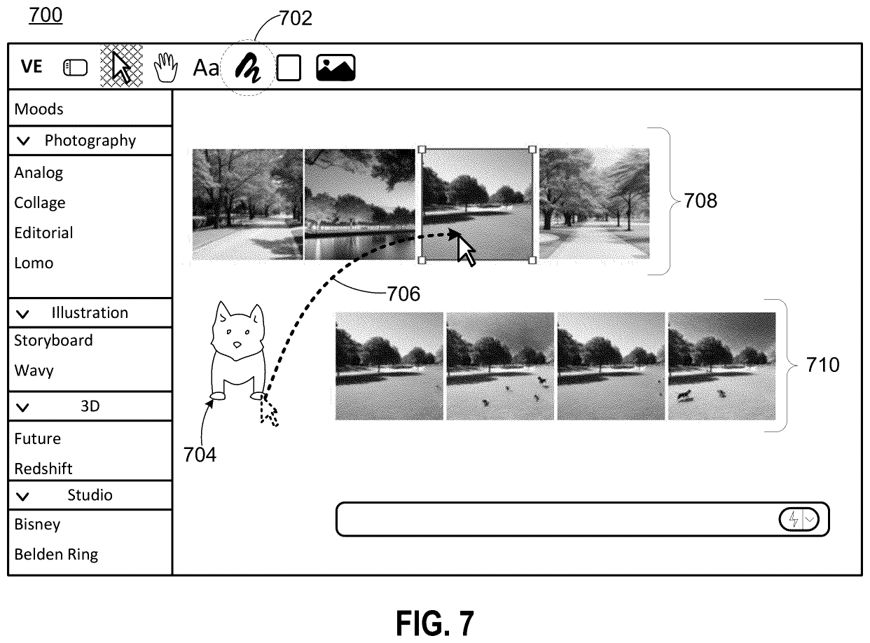

In some embodiments, the sketch fusion module 304 may track where the user has dropped a sketch and use the drop location to determine the second set of images. For example, the sketch fusion module 304 can determine the coordinates of an image that correspond to the coordinates of the infinite canvas where the sketch is dropped and subsequently determine an object is depicted in the image at the determined coordinates of the image. Using the user's dropped location and the target object onto which the sketch is placed, the sketch fusion module 304 can then determine a text prompt for generating new images and/or generate a new image for image-to-image media content generation. One example of modifying media content by dropping a sketch into the media content is depicted and described with respect to FIG. 7.

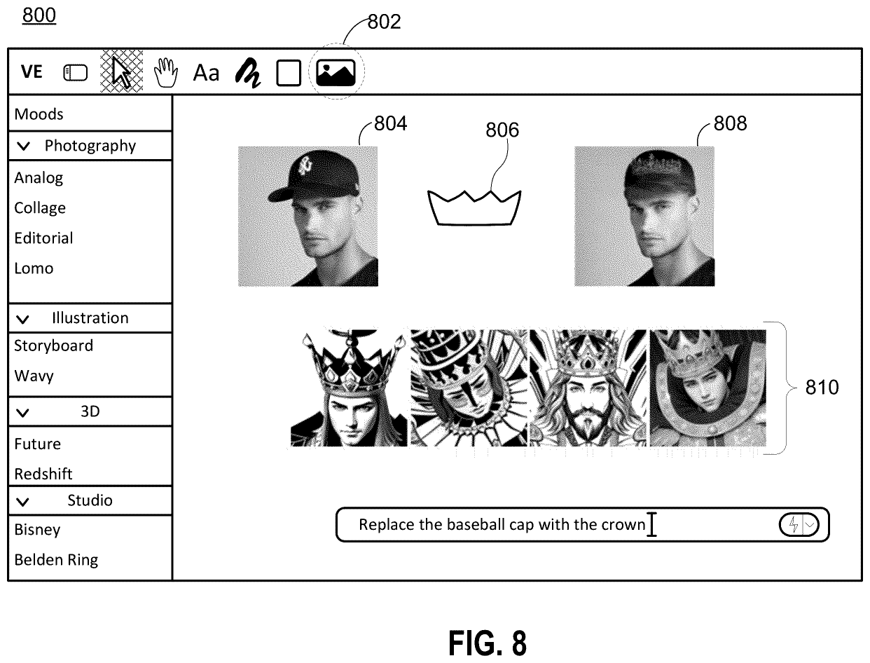

The sketch fusion module 304 can modify an image based on a sketch drawn by a user. A user may select an image uploader tool of the generative design system 300 to upload an image (e.g., from storage at the user's client device to a database of the generative design system 300). The uploaded image may depict one or more objects. The user may create a sketch depicting an object. The user may provide a text prompt to the sketch fusion module 304 (e.g., “Replace . . . ,” “Add . . . ,” etc.). In response to receive the prompt, the generative design system 300 may generate an image and/or a set of images based on the prompt. The generated image can be a modified version of the uploaded image, where the modification is determined by the sketch fusion module 304 based on the entered prompt. One example of this modification is depicted and described with respect to FIG. 8.

The sketch fusion module 304 may use an inpainting model to replace an identified object in media content with another identified object. In some embodiments, the sketch fusion module 304 may generate a set of images using text-to-image or image-to-image generation. In an example of text-to-image generation, the sketch fusion module 304 may determine a text prompt including an object in the image and an object in the sketch. The sketch fusion module 304 may then generate the set of images using the determined text prompt. In an example of image-to-image generation, the sketch fusion module 304 may apply a diffusion model to the image to generate the set of images.

The inpainting module 306 can modify an image by selecting a portion of the image to modify and applying an inpainting model to re-generate the selected portion. The user may select a portion of an image using a tool of the generative design system 300 (e.g., a cursor or pen tool). The inpainting module 306 may use an inpainting model, a selected portion of an image, and the image to regenerate the portion of the image (i.e., to produce a new set of images with the regenerated portion or replace the existing image on the infinite canvas).

In some embodiments, the inpainting module 306 applies inpainting to an image located at the infinite canvas using one or more other images at the infinite canvas. For example, the inpainting module 306 may identify a set of images located proximate to a target image to which inpainting is applied. This image may be referred to as a “target inpainting image” or a “target image” given the appropriate context. To perform the identification, the inpainting module 306 may use a predefined radius of pixels of the target image, a user selection of a radius, a radius based off the size of the image (e.g., a radius that is a multiplicative factor of the width or height of the image), any suitable distance for identifying proximate images, or a combination thereof. In some embodiments, the inpainting module 306 may identify a set of images having depicted content relevant to content of a target image to which inpainting is applied. For example, the inpainting module 306 may determine content of an image on the infinite canvas using one or more of a text prompt or image used to generate the image or object classification (e.g., using a machine learning model).

In some embodiments, the inpainting module 306 may identify relevant content by comparing the target image(s) to other images at the infinite canvas. For example, the inpainting module 306 may generate vector representations of the images at the infinite canvas, determine similarities between the vector representations, and determine relevancy based on a level of similarity (e.g., an increased similarity corresponds to an increased relevancy). In some embodiments, the inpainting module 306 uses a measure of user satisfaction to identify the one or more other images at the infinite canvas for applying inpainting to a target image. For example, the inpainting module 306 may identify images that have a threshold measure of satisfaction. The measure of satisfaction may be provided by the user or determined by the inpainting module 306 based on a number or frequency of user interactions with an image (e.g., the more interaction with a particular image, the higher the level of satisfaction the user has with the image relative to other images that are interacted with less).

In response to identifying the images, the inpainting module 306 can compare one or more objects depicted in a selected portion of a target image to one of more objects in the identified images. The inpainting module 306 may generate a set of images replacing the selected portion with a similar portion in the identified images (e.g., replace using a similar object).

The outpainting module 308 may outpaint an image of an infinite canvas using a rolling window. The outpainting module 308 can iteratively fill in a portion of the rolling window based on the image (e.g., the portion of the image that is within the window). The outpainting module 308 may use a model to determine a distance to move the rolling window and iteratively outpaint an image. The image to be outpainted may be referred to as a “target outpainting image” or “target image” given the context. During the iterative outpainting, the outpainting module 308 may determine different distances to move the rolling window at each iteration. The outpainting module 308 may determine to increase the distance responsive to receiving user feedback indicating an at or above-threshold satisfaction level for the iteratively outpainted image and determine to decrease the distance responsive to receiving user feedback indicating a below threshold satisfaction level. The outpainting module 308 may determine to increase or decrease the distance based on the content within the target image. For example, the outpainting module 308 may determine that the content of a target image spans a large variety of objects, colors, textures, etc. The outpainting module 308 may use autocorrelation or any suitable comparative operation to determine that the target image has a large variety within its own content. In response to determining that the target image has at least a threshold variation within itself, the outpainting module 308 may determine to decrease or begin with a small window size for outpainting (e.g., having a fourth of the width of the image and the same height). In response to determining that the target image does not have a threshold variation within itself, the outpainting module 308 may determine to increase or begin with a large window size for outpainting (e.g., having the same dimensions as the image itself.

The databases 310 may store generated media content, user profile information, any suitable information for creating media content using machine learning, or a combination thereof. User profile information may include information related to the user (e.g., field of employment, location, age, etc.), information related to how the user uses the generative design system 300 (e.g., history of prompts provided to the generative design system, history of tools used, etc.), any suitable information related to a given user of the generative design system 300, or combination thereof.

The model(s) 312 may include one or more machine learning models for modifying and/or generating media content and/or prompts for modifying and/or generating media content. In some embodiments, the generative design system 300 generates recommended text prompts for display at a client device using one or more images presently displayed at the infinite canvas. The generative design system 300 may apply one or more machine learning models to generate a text prompt that is likely to be selected by the user based on the one or more images presently displayed at the infinite canvas (e.g., generating a text prompt related to modifying the one or more images). The generative design system 300 may use the state of the identified subset of images to generate the recommended text prompts. For example, the generative design system 300 may use the tracked order at which the subset of images was generated and/or the number of times at which the images were interacted with to determine an order at which to present the recommended text prompts. In some embodiments, the generative design system 300 may use the text prompts and/or identified objects within the image (e.g., identified based on image classification) used to generate the subset of images to determine the recommended text prompts.

The generative design system 300 may modify content by substituting a first content item attribute for a second content item attribute. This substitution may be referred to as “remixing.” The generative design system 300 may receive a user request to remix one or more content items (e.g., images). In some embodiments, the tool menu 112 may include a selectable icon for requesting the remix of one or more content items. The user request may be an interaction with a content item in the infinite canvas. For example, the generative design system 300 receives a user selection of a “remix” tool in the tool menu 112 and used a cursor to drag and drop one or more images over to a target image on the infinite canvas. In another example, the generative design system 300 receives a combination of a selection of a content item on the infinite canvas and text input by the user specifying instructions for the remix. The user request may be instructions in the form of text or speech (e.g., the infinite canvas is coupled to one or more devices with a microphone and natural language processing to parse and interpret a user's command to remix a first image with a second image). The generative design system 300 may determine content item attributes of the one or more content items. For example, the generative design system 300 may access attributes tracked by the state tracking module 302 and stored in one or more of the databases 310.

The generative design system 300 may generate one or more additional content items (e.g., images) based on the attributes of the one or more content items that the user has selected for remixing. The generative design system 300 may determine permutations of the attributes for generating the additional images. In some embodiments, the generative design system 300 may determine a set of attribute permutations and select a subset of the attribute permutations for generating the additional images. For example, in response to a user requesting to remix three images each having respective subject matter and background styles, the generative design system 300 may determine nine different permutations of three image subject matters and three styles of image backgrounds. The generative design system 300 may select the subset based on the tracked states of the images on an infinite canvas. For example, the generative design system 300 may use the tracked state of one or more images' locations on the infinite canvas by selecting a subset of the permutations that have attributes of images located within a threshold distance on the infinite canvas from the images included in the user's request for remixing. The generative design system 300 may use a frequency of image attributes of images on the infinite canvas to select the subset. For example, the state tracking module 302 may track the number of images having respective subject matter(s), and the generative design system 300 may use the tracked subject matters to select a subset of images having the subject matter that appears most frequently on the infinite canvas. In some embodiments, the generative design system 300 may generate images using the total possible set of attribute permutations, provide the generated images for display on the infinite canvas, and receive user selections of a subset of the generated images to maintain on the infinite canvas. The generative design system 300 may then remove the non-selected images from display at the infinite canvas.

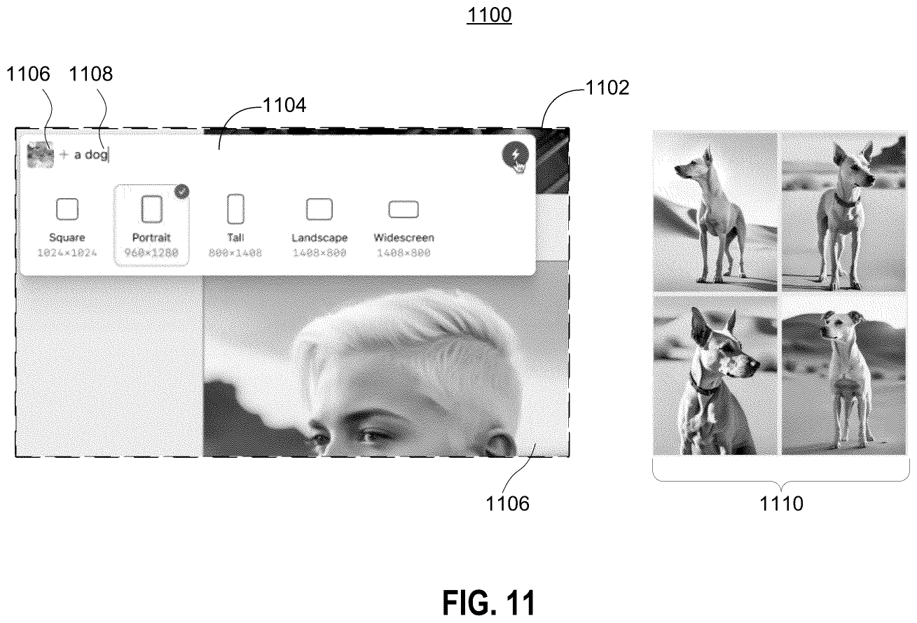

The generative design system 300 may determine an attribute that the user requests to remix based on the instructions. The generative design system 300 may use natural language processing to determine a likely category of content item attribute (e.g., a text prompt of “dog” is more likely within the category of content subject matter than background style). For example, the generative design system 300 may receive a user request including a selected image combined with user text and subsequently determine that the user text is referring to potential subject matter. The generative design system 300 may then replace the subject matter of the selected image with the subject matter referenced in the user text. One example of this is described with respect to FIG. 11.

The generative design system 300 may merge media content to modify attributes of the media content. Merging media content may also be referred to as “collaging” media content. In one embodiment of merging a first image with a second image, the generative design system 300 can modify a subject matter of the first image to have a style of the second image. In another embodiment of merging two or more images, the generative design system 300 can generate a new image that includes attributes from the two or more of the images.

The generative design system 300 may receive a user request to merge one or more images (e.g., images generated by the generative design system 300 at an infinite canvas, images uploaded to the generative design system 300 that are not necessarily generated by the generative design system 300, or a combination thereof) into a target image on the infinite canvas.

The generative design system 300 may determine, from a set of image attributes of the image(s) requested to be merged (e.g., all available image attributes), a subset of the image attributes to modify when merging the images. The generative design system 300 may determine an attribute priority, where the attribute priority represents an order in which image attributes are modified by the generative design system 300 in the merged image. For example, a background style may have the highest attribute priority and a foreground subject matter may have the lowest attribute priority. In turn, when merging one or more images into a target image, the generative design system 300 may determine to modify an attribute of the target image having the highest attribute priority while keeping other attributes of the target image the same. For example, in response to determining that a background style attribute has the highest attribute priority, the generative design system 300 may change the background style of the target image to one or a combination of the background style attributes of the one or more images being merged into the target image. The generative design system 300 may generate an image having a combination of different types of the same image attribute (e.g., a combined comic and noir style background or a combined lion and eagle foreground subject matter) by applying different generative models or layers of generative models to an image (e.g., an image to be merged). In response to the user selecting two or more images to be merged into a target image, the generative design system 300 may select a highest priority attribute from the two or more images based on one or more of an order in which the user has selected the two or more images, the distance from the two or more images to the target image on the canvas, the times at which the two or more images were generated, the frequency at which the user has previously generated images having certain image attributes, etc.

The generative design system 300 may modify a target image based on the determined subset of image attributes to modify when merging the images. In some embodiments, the generative design system 300 may replace or modify an image attribute of a target image with the corresponding image attribute of an image requested to be merged with the target image. For example, the generative design system 300 may replace the foreground subject matter in a target image with the foreground subject matter in an image requested to be merged. In another example, the generative design system 300 may modify the background style of a target image (e.g., portrait style) using the background style of the image requested to be merged (e.g., futuristic and abstract style) to create a merged background style (e.g., a futuristic portrait style). In some embodiments, the generative design system 300 may modify an image attribute of a target image using a different type of image attribute of an image requested to be merged with the target image. For example, the generative design system 300 may modify the foreground subject matter of a target image (e.g., a goat) using a background style of the image requested to be merged with the target image (e.g., futuristic style) to produce a subject matter in the background style (e.g., a goat that has cyborg-like or alien-like qualities).

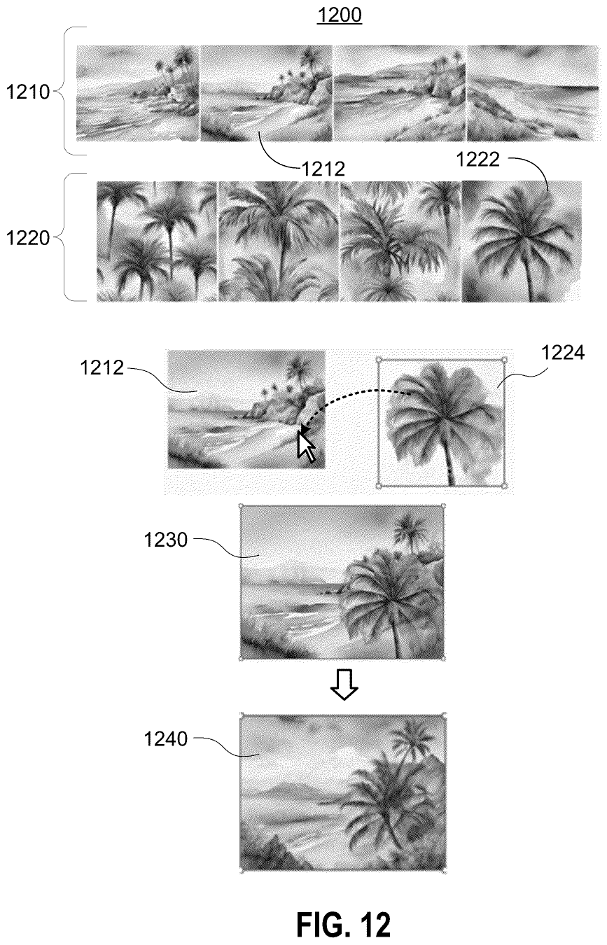

The generative design system 300 may receive a request to merge attributes from the two or more images to generate a new image with the merged attributes. For example, the generative design system 300 may request to merge subject matter from one image into a second image. The user may use the generative design system 300 to isolate the subject matter from the first image (e.g., using a “remove background” function of the generative design system 300). On the infinite canvas, the user may select, drag, and drop the isolated subject matter over the second image. The generative design system 300 may interpret this drop as the request to merge the isolated subject matter with the subject matter existing in the second image. The generative design system 300 may then generate one or more new images having the subject matter of the second image in addition to the isolated subject matter. In this generation, the generative design system 300 may maintain other existing attributes of the second image (e.g., background and/or foreground style, color, contrast, etc.) and optionally, apply attributes of the second image to the added subject matter from the first image (e.g., apply the foreground style to the added subject matter to create a cohesive merging of the first image's subject matter into the second image). One example of this is described with respect to FIG. 12.

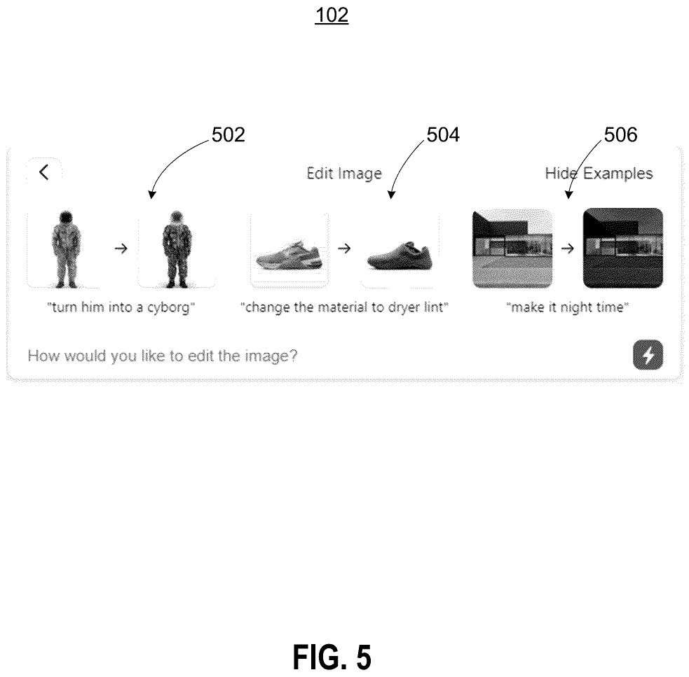

The generative design system 300 may determine a text prompt based on media content. In some embodiments, a user may use a cursor tool of the generative design system 300 to select an image or a portion of an image on an infinite canvas. The generative design system 300 receives the user selection and determines one or more attributes for the selection. For example, the generative design system 300 may receive coordinates on the infinite canvas corresponding to a cursor tool's movements during selection (e.g., coordinates of the cursor's trajectory in a free form selection or start and end coordinates of the cursor during a rectangular selection). In response to receiving the coordinates, the generative design system 300 may determine one or more images at the infinite canvas having a location that includes the received coordinates. The generative design system 300 may determine attributes of the one or more images such as subject matter depicted within the bounds of the received coordinates or style(s) of the image(s) within the bounds. The generative design system 300 may use the states tracked by the state tracking module 302 to determine the attributes. The generative design system 300 may generate a text prompt using the determined attributes and a text generation model (e.g., a large language model). For example, a user may use a cursor tool to outline a dog within an image of a dog in a park. The generative design system 300 may then identify the image that the user has selected based on the coordinates of the cursor tool during the outlining and identify attributes of the image (e.g., the subject matter includes the dog). The generative design system 300 may then generate a text prompt “a dog” based on the user selection and display the generated text prompt at the infinite canvas (e.g., at a text prompt input). The generative design system 300 may generate recommended prompts based on the clipped image. The generative design system 300 may determine recommended prompts in a fashion similar to that described with respect to FIGS. 4 and 5.

The generative design system 300 may create a personalized media content profile for a user. The personalized media content profile may include image attributes the generative design system 300 determines that a particular user is likely to use when generating media content in an infinite canvas. The generative design system 300 may create or update the personalized media content profile for a user when the user first starts using the generative design system 300, periodically as the user continues to use the generative design system 300, on-demand in response to a user request to update their personalized media content profile, or a combination thereof.

When generating a personalized media content profile for a first-time user, the generative design system 300 may generate a set of personalization media content for display at an infinite canvas in response to a user starting up the infinite canvas for the first time. For example, responsive to a user creating a profile for storage with the generative design system 300, the generative design system 300 may generate the set of personalization media content for display. The generative design system 300 may determine the set of personalization media content by determining media content having different image attributes (e.g., multiple images each having different styles, subject matter, sizes, brightness, colors, etc.). The generative design system 300 may receive a user selection of one or more media content from the set of personalization media content. Using the user selection, the generative design system 300 may generate the personalized media content profile. For example, the generative design system 300 may identify attributes of media content in the user selection and include the identified attributes and/or similar attributes in the personalized media content profile. The generative design system 300 may determine attribute similarity based on a history of user selections of image attributes (e.g., users who select a “noir” style attribute also select black and white for the colors of their media content) or based on vector representations of image attributes and similarity between vectors (e.g., cosine similarities). The generative design system 300 may store the generated personalized media content profile in the databases 310.

The generative design system 300 may update a generated personalized media content profile periodically (e.g., monthly, yearly, etc.) or in response to an event prompting an update (e.g., a user specifies that the generative design system 300 is used for a first client and in response to the user specifying that the generative design system 300 is to be used for a second client, the generative design system 300 prompts the user to create a new personalized media content profile for the second client or update the existing personalized media content profile). The generative design system 300 may receive user requests to update a generated personalized media content profile. For example, the generative design system 300 may generate a profile updating icon at the tool menu 112 for a user to select for updating their personalized media content profile. In response to determining to update the personalized media content profile (e.g., in response to a period of time passing, a prompting event occurring, or a user request to update), the generative design system 300 may generate a set of personalization media content, which may be a different set of media content than used when the user initially begins using the generative design system 300. For example, the generative design system 300 may generate a set of personalization media content that includes different attributes selected from a subset of attributes that the user has used above a first threshold frequency or that the user has used below a second threshold frequency.

FIG. 4 depicts a user interface 400 for recommending media content design prompts based on images displayed on an infinite canvas, in accordance with one embodiment. A user may use the generative design system 300 to create a first set 402 of images (e.g., by providing a prompt “snow sports” into the text prompt input 102). The user may then use the generative design system 300 to create a second set 404 of images (e.g., by providing a prompt “tree in winter” into the text prompt input 102). The generative design system 300 may use the first set 402 and second set 404 of images to generate recommended text prompts 406 for display at the text prompt input 102. The recommended text prompts generated by the generative design system 300 may be in the form of a natural language output. The generative design system 300 may use prompts previously provided by the user or multiple users to train a model (e.g., large language models or other suitable machine learning models) to determine prompts 406 to recommend. For example, the generative design system 300 may train a machine learning model to predict likely text prompts based on historical sequences of text prompts. The generative design system 300 may apply a machine learning model to determine one or more text prompts that a user is likely to select. In some embodiments, the generative design system 300 may re-train a model in response to a user selecting or ignoring text prompts generated by the model.

The generative design system 300 may group users based on user profile information (e.g., users in a similar region or location, users in an age group, users associated with the same corporate entity, etc.) or media content generated (e.g., users who have previously generated media content related to sports). Based on the user grouping, the generation design system 300 may determine natural language prompts to provide to users.

FIG. 5 depicts an example embodiment of a text prompt input 102 including recommended prompts for designing media content. The text prompt input 102 includes recommendations 502, 504, and 506 for modifying media content. In some embodiments, the generative design system 300 can generate one or more of the recommendations 502, 504, and 506 based on media content that is generated for display at the infinite canvas. For example, the user may use the generative design system 300 to generate images on the infinite canvas, and the generative design system 300 may identify a subset of the generated images presently within the user's view (e.g., based on the size of the application window and where a user has used a grabber tool on the infinite canvas to move the infinite canvas around). The generative design system 300 may generate recommended text prompts for display at the text prompt input 102 using the identified subset of images. The generative design system 300 may use the state of the identified subset of images to generate the recommended text prompts. For example, the generative design system 300 may use the tracked order at which the subset of images was generated and/or the number of times at which the images were interacted with to determine an order at which to present the recommended text prompts. In some embodiments, the generative design system 300 may use the text prompts and/or identified objects within the image (e.g., identified based on image classification) used to generate the subset of images to determine the recommended text prompts. The generative design system 300 may determine attributes similar to the attributes of one or more images at the infinite canvas to determine recommended text prompts (e.g., the system may recommend a “comic” style in response to determining that the present image style is a “storyboard” style). The generative design system 300 may determine attributes based on trends among multiple users (e.g., the system recommends a “futuristic” image style in response to determining that the image subject matter is a robot and that a group of users have previously applied a “futuristic” image style to images of robots).

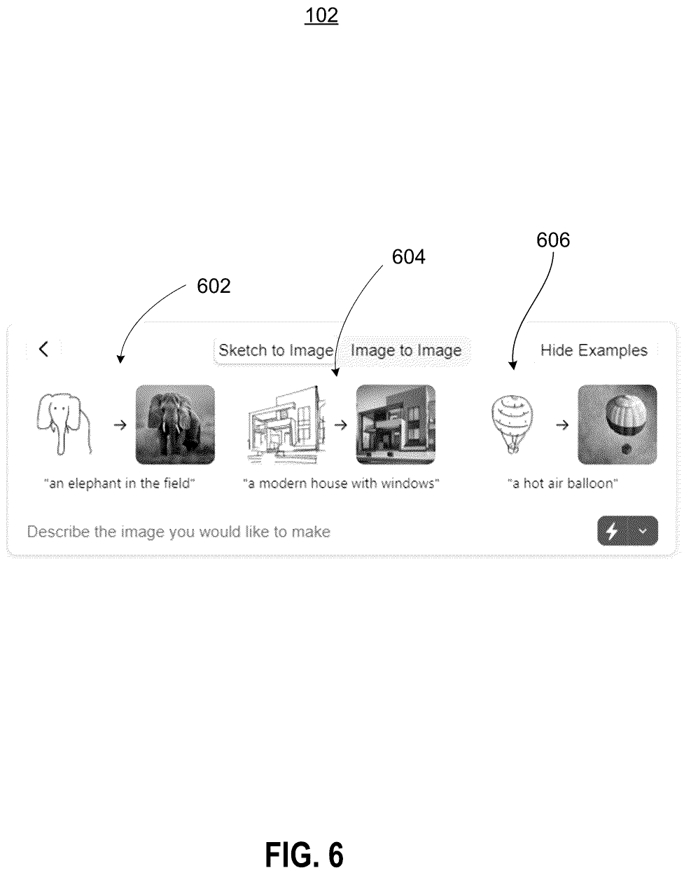

FIG. 6 depicts an example embodiment of a text prompt input 102 including recommended prompts for generating media content based on a sketch. The text prompt input 102 includes recommendations 602, 604, and 606 for generating media content. In some embodiments, the generative design system 300 can generate one or more of the recommendations 602, 604, and 606 based on one or more user sketches on an infinite canvas. For example, a user may draw a hot air balloon using a pen tool of the generative design system 300, the user may use a cursor tool of the generative design system 300 to select the sketch of the hot air balloon, and in response, the generative design system 300 may generate the recommended text prompt 606 for the user to select. In response to selecting one of the recommendations 602, 604, or 606, the generative design system 300 may generate media content resembling the sketch.

FIG. 7 depicts a user interface 700 for modifying media content based on a user's sketch drawn on an infinite canvas, in accordance with one embodiment. A user may use a pen tool 702 to draw a sketch 704 of a dog on the infinite canvas. The user may generate a first set 708 of images of a park using the generative design system 300. The user may use the cursor tool to drag 706 the sketch 704 into one of the images of the first set 708 of images and in response, the generative design system 300 can create a second set 710 of images that combine the sketch 704 and the image into which it was dropped. The generative design system 300 can determine the second set 710 of images by identifying one or more objects of the sketch 704 and using at least the identified one or more objects to generate the second set 710 of images. For example, the generative design system 300 identifies the sketch 704 includes a dog. The generative design system 300 can use machine learning models to identify one or more objects in a user's sketch. The generative design system 300 may modify (e.g., augment) the instructions used to generate the first set 708 of images using the one or more identified objects. For example, after identifying a dog is in the sketch 704, the generative design system 300 may add a keyword “dog” to the text prompt of “park” used to generate the first set 708 of images.

In some embodiments, the generative design system 300 may track where the user has dropped a sketch and use the drop location to determine the second set 710 of images. For example, the generative design system 300 can determine the coordinates of an image that correspond to the coordinates of the infinite canvas where the sketch 704 is dropped and subsequently determine a lawn is depicted in the image at the determined coordinates of the image. Using the user's dropped location and the target object onto which the sketch is placed, the generative design system 300 can then determine a text prompt for generating new images and/or generate a new image for image-to-image media content generation. For example, the generative design system 300 can determine a text prompt of “dog on a lawn at a park” to generate the second set 710 of images. In another example, the generative design system 300 can overlay the sketch 704 of the dog onto the image of a park and generate the second set 710 of images based on an image of the dog overlaid onto a park.

FIG. 8 depicts a user interface 800 for modifying an image 804 based on a sketch 806, in accordance with one embodiment. A user may select an image uploader 802 tool of the generative design system 300 to upload the image 804 from storage at the user's client device to a database of the generative design system 300. The image 804 depicts a person in a baseball cap. The user may create the sketch 806, which depicts a crown. The user may enter a prompt of “Replace the baseball cap with the crown” into the text prompt input 102. In response to receive the prompt, the generative design system 300 may generate an image 808 and/or a set 810 of images. The image 808 can be a modified version of the uploaded image 804, where the modification is determined by the generative design system 300 based on the entered prompt. That is, the generative design system 300 may identify a baseball cap within the image 804 and replace the identified baseball cap with the crown in the sketch 806. Although not depicted as identical, the crown used in the image 808 may be identical to sketched crown or substantially identical (i.e., rotated, resized, recolored, etc. to appear more naturally integrated in the resulting image 808). The generative design system 300 may use an inpainting model to replace an identified object in media content with another identified object. In some embodiments, the generative design system 300 may generate the set 810 of images using text-to-image or image-to-image generation. In an example of text-to-image generation, the generative design system 300 may determine a text prompt including an object in the image 804 (e.g., person) and an object in the sketch 806 (e.g., a crown). The generative design system 300 may then generate the set 810 using the determined text prompt. In an example of image-to-image generation, the generative design system 300 may apply a diffusion model to the image 808 to generate the set 810 of images.

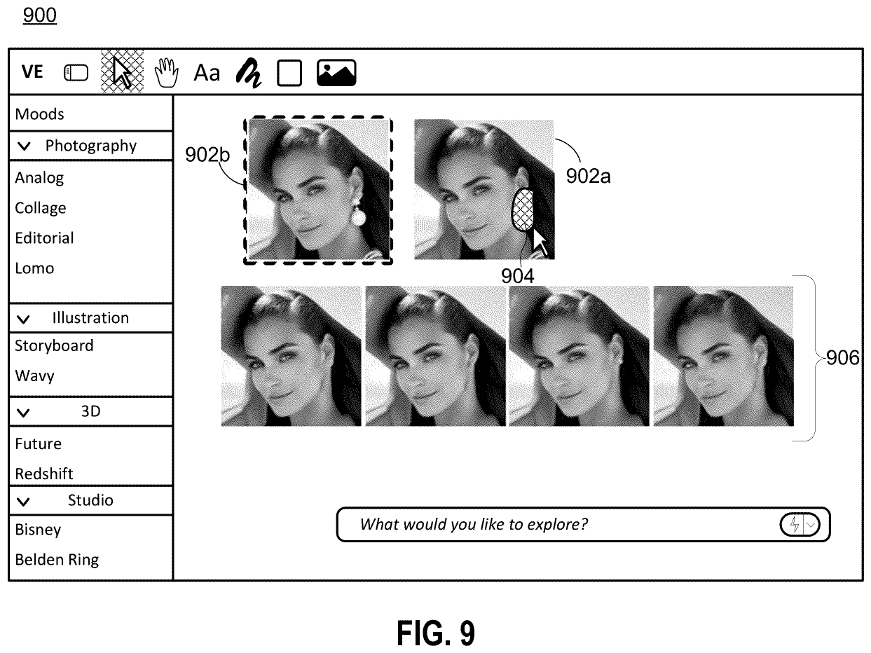

FIG. 9 depicts a user interface 900 for inpainting in an infinite canvas, in accordance with one embodiment. A user may instruct the generative design system 300 to modify an image 902a by selecting a portion 904 of the image 902a to modify. The image 902b is the same image as 902a without a visual artifact of the user's selection of the portion 904 blocking the image. The portion 904 corresponds to a user selection of an earring depicted in the image 902a. The user may select the portion 904 using a tool of the generative design system 300 (e.g., a cursor or pen tool). The generative design system 300 may use an inpainting model, the selected portion 904, and the image 902a to produce a set 906 of images. The set 906 of images includes a modified version of the portion 904, including the earring depicted in the image 902b.

In some embodiments, the generative design system 300 applies inpainting to an image located at the infinite canvas using one or more other images at the infinite canvas. For example, the generative design system 300 may identify a set of images located proximate to a target image to which inpainting is applied. To perform the identification, the generative design system 300 may use a predefined radius of pixels of the target image, a user selection of a radius, a radius based off the size of the image (e.g., a radius that is a multiplicative factor of the width or height of the image), any suitable distance for identifying proximate images, or a combination thereof. In some embodiments, the generative design system 300 may identify a set of images having depicted content relevant to content of a target image to which inpainting is applied. For example, the generative design system 300 may determine content of an image on the infinite canvas using one or more of a text prompt or image used to generate the image or object classification (e.g., using a machine learning model).

In some embodiments, the generative design system 300 may identify relevant content by comparing the target image(s) to other images at the infinite canvas. For example, the generative design system 300 may generate vector representations of the images at the infinite canvas, determine similarities between the vector representations, and determine relevancy based on a level of similarity (e.g., an increased similarity corresponds to an increased relevancy). In some embodiments, the generative design system 300 uses a measure of user satisfaction to identify the one or more other images at the infinite canvas for applying inpainting to a target image. For example, the generative design system 300 may identify images that have a threshold measure of satisfaction. The measure of satisfaction may be provided by the user or determined by the generative design system 300 based on a number or frequency of user interactions with an image (e.g., the more interaction with a particular image, the higher the level of satisfaction the user has with the image relative to other images that are interacted with less).

In response to identifying the images, the generative design system 300 can compare one or more objects depicted in a selected portion (e.g., the selected portion 904) to one of more objects in the identified images. The generative design system 300 may generate a set of images replacing the selected portion with a similar portion in the identified images (e.g., replace using a similar object).

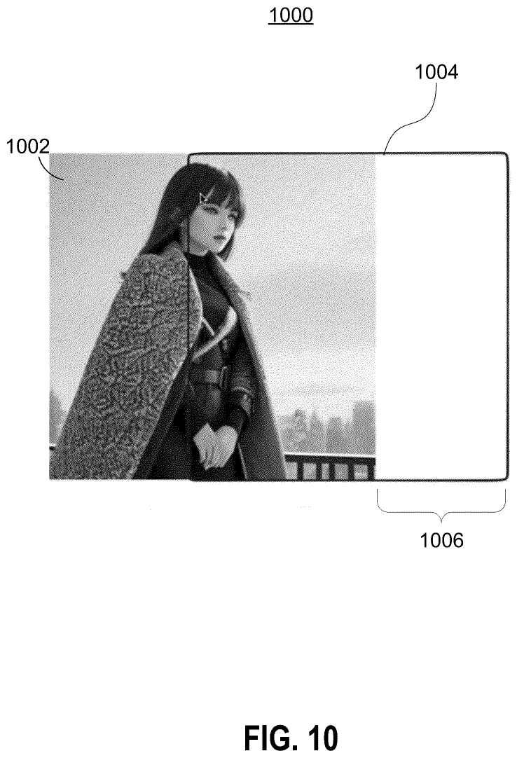

FIG. 10 depicts an example embodiment 1000 of outpainting of an image 1002, in accordance with one embodiment. The generative design system 300 may determine to outpaint the image 1002 using a rolling window 1004. The generative design system 300 can iteratively filling in a portion 1006 of the window 1004 based on the image 1002 (e.g., the portion of the image 1002 that is within the window 1004 but not the portion 1006). The generative design system 300 may use a model to determine a distance to move the rolling window 1004 and iteratively outpaint the image 1002. The generative design system 300 may determine to increase the distance responsive to receiving user feedback indicating an at or above-threshold satisfaction level for the iteratively outpainted image and determine to decrease the distance responsive to receiving user feedback indicating a below threshold satisfaction level.

The generative design system 300 may determine to increase or decrease the distance based on the content within the image 1002. For example, the generative design system 300 may determine that the content of the image 1002 spans a large variety of objects, colors, textures, etc. The generative design system 300 may use autocorrelation or any suitable comparative operation to determine that the image 1002 has a large variety within its own content. In response to determining that the image 1002 has at least a threshold variation within itself, the generative design system 300 may determine to decrease or begin with a small window size for outpainting (e.g., having a fourth of the width of the image and the same height). In response to determining that the image 1002 does not have a threshold variation within itself, the generative design system 300 may determine to increase or begin with a large window size for outpainting (e.g., having the same dimensions as the image itself).

FIG. 11 depicts an example embodiment 1100 of content item remixing. The generative design system 300 may generate an image 1106 at an infinite canvas 1102. The state tracking module 302 may track states of the image 1106 such as a time the image 1106 was generated, a prompt used to generate the image 1106 (e.g., “a woman in the desert”), a location of the image 1106 at the infinite canvas 1102, attributes of the image 1106 (e.g., subject matter is “a woman,” background is “desert,” image style is “portrait,” etc.), a size of the image (e.g., 960×1280 pixels), etc. The generative design system 300 may receive a user request to remix the image 1106 with a text prompt 1108 within an input box 1104. The text prompt 1108 specifies “a dog” for remixing with the image 1106. The generative design system 300 may access attributes of the image 1106 and replace an attribute of the image 1106 with an attribute associated with the text prompt 1108. For example, the generative design system 300 may determine, using natural language processing, that the text prompt 1108 of “a dog” is likely to refer to the subject matter of the desired remixed image. In another example, the generative design system 300 may provide a selection menu for the user to select which attributes the user would like to remix (e.g., a table showing image attributes including the subject matter, which the user can select using a cursor tool and request to change through the text prompt 1108). The generative design system 300 may generate the set of images 1110 by replacing the subject matter of the image 1106 (i.e., “woman”) with the requested subject matter from the text prompt 1108 (i.e., “dog”). The set of images 1110 maintain other image attributes such as the size or a proportionate size, the background, and the style of the image. However, the generative design system 300 has replaced the subject matter so that the images 1110 depict a dog in the desert with the portrait style of image 1106. In the generated images 1110, the generative design system 300 may modify the appearance of an attribute while maintaining it; for example, the generative design system 300 may modify the appearance of the background, a desert, while maintaining the appearance of the desert in the background.

FIG. 12 depicts an example embodiment 1200 of content item collaging. The generative design system 300 may generate a first set of images 1210 depicting a beach and a second set of images 1220 depicting palm trees. The user may select image 1222 of the second set of images 1220 and use the generative design system 300 to isolate the subject matter (i.e., a palm tree) from the background of the image 1222. The generative design system 300 produces an image 1224 depicting the isolated subject matter without the background of the image 1222. The user may drag and drop the image 1224 into the image 1212 of the first set of images 1210. The user may select a “collage” tool from a tool menu of the generative design system 300 before or after dropping the image 1224 into the image 1212. The image 1230 is a depiction of the image 1224 overlaid on the image 1212 before the generative design system 300 has collaged the two images. In response to the user dropping the image 1224 into the image 1212, the generative design system 300 can collage the images 1224 and 1212 together to form the image 1240. The generative design system 300 can generate the image 1240 using the existing attributes of the image 1212 and the added attribute from the image 1224, which includes the subject matter (i.e., the palm tree). The generative design system 300 can generate a new image having merged attributes that appear the same as depicted in the original images, having merged attributes that appear different, or a combination thereof. The embodiment 1200 depicts the newly generated image 1240 having merged attributes that appear differently than the original images. For example, the subject matter like the waves, sand, palm trees, and mountains have the same style and position as the depicted in the image 1230 (the combination of the original images) but are rendered differently than depicted in the image 1230.

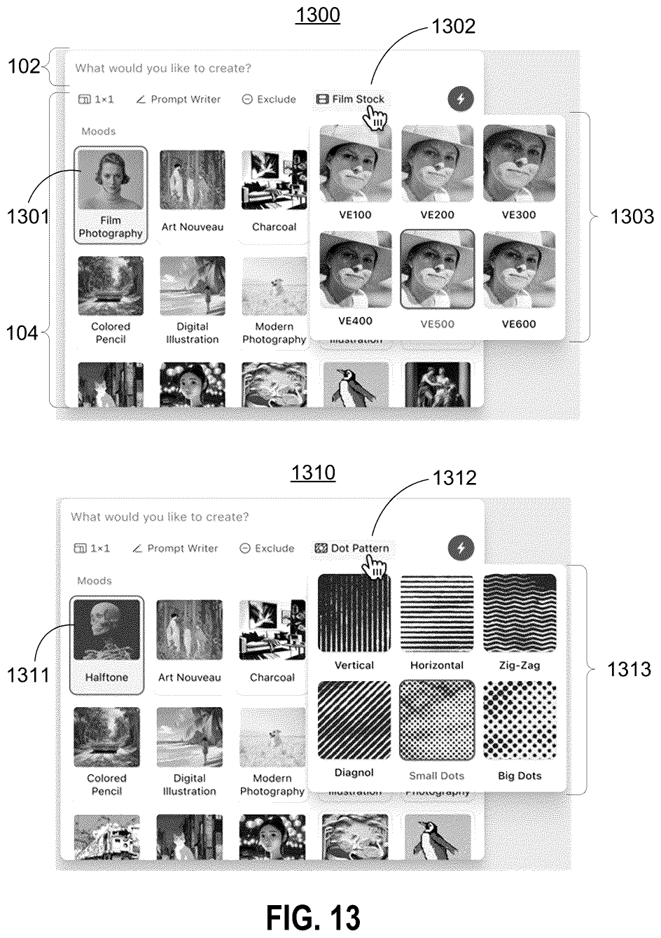

FIG. 13 depicts two example embodiments 1300 and 1310 of sub-moods for content item generation or editing. The generative design system 300 may provide a list of moods that a user can select to generate new media content on an infinite canvas or edit existing media content on the infinite canvas. For example, the generative design system 300 may provide the list of moods through a style menu 104 and/or the text prompt input 102. In some embodiments, the style menu 104 may be integrated with the text prompt input 102. For example, the text prompt input 102 may be attached to the style menu 104 or the style menu 104 may expand from the text prompt input 102 in response to a user interaction with the text prompt input 102. In addition to providing the list of moods, the generative design system 300 may provide a list of sub-moods. A sub-mood may be a more specific mood categorized within the broader mood. In an example embodiment 1300 of offering sub-moods for user selection, the generative design system 300 offers a “film photography” mood 1301 and sub-moods options 1303 under a sub-mood 1302 of “film stock.” Other examples of sub-moods under the “film photography” mood 1301 may be “instant film,” “color negative film,” “slide film,” or any suitable type of film photography. In an example embodiment 1310 of offering sub-moods for user selection, the generative design system 300 offers a “halftone” mood 1311 and sub-mood options 1313 under a sub-mood 1312 of “dot pattern” (i.e., each sub-mood option 1313 is a different type of dot pattern for halftone images). Other examples of sub-moods under the “halftone” mood 1311 may be digital halftoning, inverse halftoning, or any suitable type of halftoning.

The generative design system 300 may incorporate sub-moods into media content generation, media content editing, prompt recommendation, or any suitable process described herein. For example, the generative design system 300 may remix an image to generate new images with different sub-moods for display at the infinite canvas. In another example, the generative design system 300 may generate a prompt recommending that a user edit an existing image on the infinite canvas by applying a sub-mood or selecting a different sub-mood. In some embodiments, the generative design system 300 may generate the sub-moods for display based on a likelihood that a user will select a sub-mood. For example, the generative design system 300 may generate the list of sub-mood options 1313 ordered by most to least frequency used.

In some embodiments, the generative design system 300 may generate the list of sub-mood options 1313 based on one or more media content on the infinite canvas. For example, the generative design system 300 may determine that a user has selected a particular image on the infinite canvas and a mood at the style menu 104, apply attributes of the image and a selected mood to one or more models, and determine sub-moods options to display based on the output of the model(s). The one or more models used to determine sub-mood options for display may be of the model(s) 312 of the generative design system 300. The model(s) may be trained using a history of previously applied sub-moods and the corresponding media content (e.g., the attributes of the media content) to which the sub-moods were applied. In some embodiments, a model may be tailored to a particular user (e.g., the model may be trained using the user's history of previously applied sub-moods). A model may be trained to output one or more likely sub-moods based on an input of media content attributes. Additional inputs based on media contents on the infinite canvas may be used to determine a likely sub-mood. For example, the generative design system 300 may determine a likely sub-mood based on a chronology of media content generated for display at the infinite canvas and/or a location of the media content displayed on the infinite canvas. The generative design system 300 may use the proximity of images with a user-selected image to determine a likely sub-mood to recommend to the user.

In some embodiments, the generative design system 300 can make generative content text prompt suggestions. For instance, as a user is typing a text prompt to generate content (or as the user has partially entered a text prompt), the generative design system 300 can identify one or more additions to the text prompt that the user may want to incorporate into the entered text prompt, and can modify a text prompt entry user interface element to include the identified text prompt additions as a first set of text prompt suggestions.

The user interface element can enable the user to select one of the suggested text prompt additions, and in response to the selection of the suggestion, can both modify the text prompt entry user interface element to include the selected text prompt suggestion and can include text prompt additions that can be displayed as a second set of text prompt suggestions within the text prompt entry user interface element to the user. In some embodiments, the first set of text prompt suggestions can include all or part of the partial text prompt entered by the user. Likewise, in some embodiments, the second set of text prompt suggestions can include all or part of the selected text prompt suggestion.

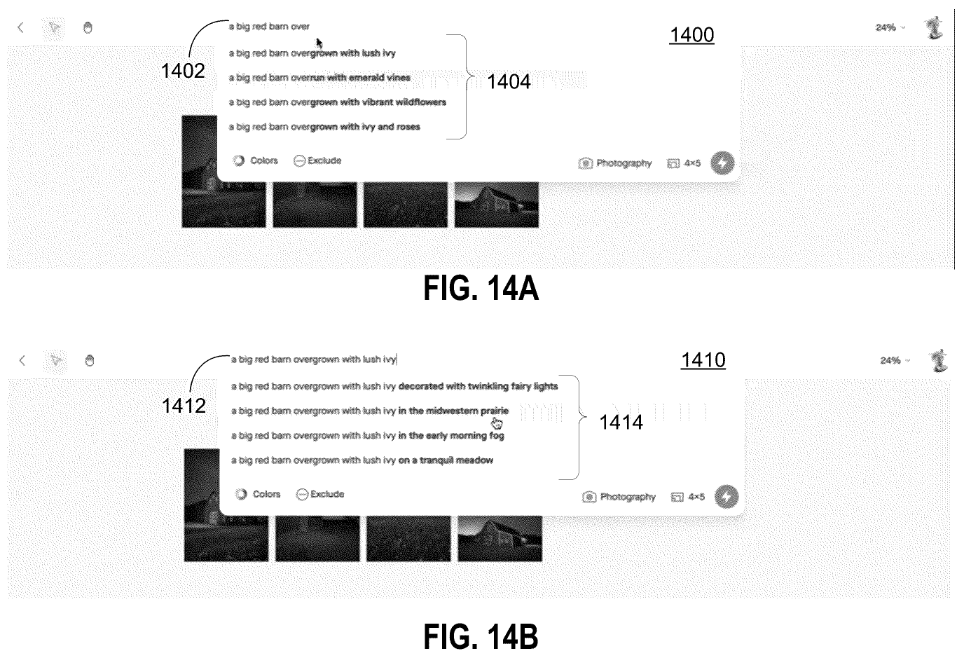

FIG. 14A depicts a text prompt suggestion interface suggesting a first set of text prompt additions, according to one embodiment. In the embodiment of FIG. 14A, a user has entered a first partial text prompt 1402 within the text prompt entry user interface element 1400. Specifically, the user has entered the text “a big red barn over” into a field of the text prompt entry user interface element 1400, and a first set of text prompt suggestions 1404 is displayed under the field. The first set of text prompt suggestions 1404 includes “a big red barn overgrown with lush ivy”, “a big red barn overrun with emerald vines”, “a big red barn overgrown with vibrant wildflowers”, and “a big red barn overgrown with ivy and roses”.

FIG. 14B depicts the text prompt suggestion interface of FIG. 14A suggesting a second set of text prompt additions, according to one embodiment. In the embodiment of FIG. 14B, the user from the embodiment of FIG. 14A has selected the suggested text prompt “a big red barn overgrown with lush ivy” from the first set of text prompt suggestions 1404. As a result, the text prompt entry user interface element 1410 modifies the partial text prompt 1412 to change the text entered by the user from “a big red barn over” to “a big red barn overgrown with lush ivy”. In response, a second set of text prompt suggestions 1414 is selected based on the text “a big red barn overgrown with lush ivy” and is displayed under the text prompt entry field. The second set of text prompt suggestions 1414 includes “a big red barn overgrown with lush ivy decorated with twinkling fairy lights”, “a big red barn overgrown with lush ivy in the midwestern prairie”, “a big red barn overgrown with lush ivy in the early morning fog”, and “a big red barn overgrown with lush ivy on a tranquil meadow”. As with the embodiment of FIG. 14A, if a user selects one of the second set of text prompt suggestions 1414, the partial text prompt 1412 can be modified to include the text of the selected suggestion from the second set of text prompt suggestions”.

The text of the text prompt suggestions (also referred to as the text prompt additions) can be identified based on a number of different factors. In some embodiments, the text prompt additions can be selected based on subject matter of a partial text prompt entered by a user. For instance, if the partial text prompt identifies an object, then the text prompt additions can include text describing a state, condition, characteristic, or context of or associated with the object. Thus, if a partial text prompt includes the text “a young man”, text prompt additions can be selected to include “on a beach”, “holding a backpack”, “with a young woman”, and the like. The text prompt additions can each describe a modification, addition, or removal of subject matter from images that would be generated based on the partial text prompt.

In some embodiments, the text prompt additions can be selected based on what other users are entering for text prompts. For instance, if a user enters three consecutive words in a text prompt field, then a threshold number of most common text prompts that begin with the entered three consecutive words across all other users or a subset of users of the generative design system 300. In some embodiments, the subset of users can include users with one or more characteristics in common with the user that entered the partial text prompt, such as users in a similar geographic area as the user, users around the same age as the user, users in a same profession as the user, and the like.

In some embodiments, the text prompt additions can be selected based on text prompts previously entered by the user. For instance, if a user has previously entered the text prompt “a puppy riding a skateboard”, then when the user subsequently enters the text “a puppy”, the text prompt “a puppy riding a skateboard” can be included in the text prompt suggestions. In some embodiments, the text prompt additions can be selected based on content within a current white board or canvas of the user within the generative design system 300. For instance, if the user is working on a canvas that includes images of a highway in a city at night time, then when the user enters the partial text prompt “a sports car”, the text prompts “a sports car on a highway”, “a sports car in a city”, “a sports car at night time”, and “a sports car on a highway in a city at night time” can be suggested to the user.

In some embodiments, a first set of images can be generated based on a first partial text prompt (such as the partial text prompt “a big red barn over” 1402 from the embodiment of FIG. 14A). For instance, a set of images of a big red barn can be generated via the generative design system 300 in response to the user typing in “big red barn” in a prompt interface element displayed to the user. When a user selects a first prompt from the resulting set of text prompt suggestions (such as the prompt suggestion “a big red barn overgrown with lush ivy” from the prompt suggestions 1404 from the embodiment of FIG. 14A), the generated set of images can be modified to include the additional detail from the selected text prompt suggestion. For instance, if the user selects “a big red barn overgrown with lush ivy” from the text suggestions, the previously generated set of images of a big red barn, the previously generated set of images can be modified such that the barns within the images are instead shown as overgrown with ivy. For instance, the previously generated set of images can be provided as an input to the generative design system 300, which in turn can perform one or more generative content operations on the set of images (such as an image processing operation, a subject matter modification operation, a subject matter addition operation, a subject matter removal operation, one or more color palette-based operations, and the like) to include content corresponding to the selected suggested text prompt.

In some embodiments, the set of images can be re-generated based on the selected suggested text prompt. For example, the generative design system 300 generates a set of images using the prompt “a big red barn overgrown with lush ivy”. In some embodiments, a second set of images can be generated next to the first set of images. For instance, the generative design system 300 generates the second set of images using the prompt “a big red barn overgrown with lush ivy” and displays this set of images next to the first set of images generated using the prompt “a big red barn”. This allows a user to see the differences between the first set of images (generated with a partial prompt) and the second set of images (generated using a selected suggested prompt).

In some embodiments, if the generated set of images is modified using a selected suggested text prompt, the set of images can be modified a second time using a second selected suggested text prompt. For instance, if the user selects the second suggested text prompt “a big red barn overgrown with lush ivy in the early morning fog” from the second set of text prompt suggestions 1414 of FIG. 14B, then the previously modified set of images of big red barns overgrown with ivy can be further modified by the generative design system 300 to include fog in an early morning setting (for instance by applying one or more generative content operations on the set of images to include content representative of fog in the early morning). Likewise, the generative design system 300 can generate the set of images from scratch using the second selected suggested text prompt, and can display this set of images next to the previously generated sets of images, allowing the user to see how the selected suggested text prompts have changed the generated images over time.

In some embodiments, the generative design system 300 can include a color palette selection interface in conjunction with a text prompt interface for use in generating images. The color palette selection interface can include a plurality of selectable color interface elements, each displayed with a representation of a different color (e.g., the interface may include a set of selectable buttons that are each a different color). Users can select one or more of the displayed color interface elements, and the generative design system 300, in response to receiving a selection of a subset of the color interface elements, can generate a set of images in which the colors corresponding to the selected color interface elements dominate or are prominently featured. In some embodiments, the set of images can be generated based on a text prompt (e.g., the subject matter of the images comes from the text prompt), while the color features and palette of the subject matter is based on the selected color interface elements.

In some embodiments, images generated based on selected colors or color shades can include more than threshold number or percentages of pixels that are within a threshold shade or color of the selected colors or color shades. In some embodiments, images generated based on selected colors or color shades include one or more of objects, people, animals, foregrounds, backgrounds, or other subject matter that predominantly include the selected colors or color shades (e.g., more than a threshold percentage of the image portions include colors similar to the selected colors or color shades), while the remainder of the images do not necessarily include the selected colors or color shades.

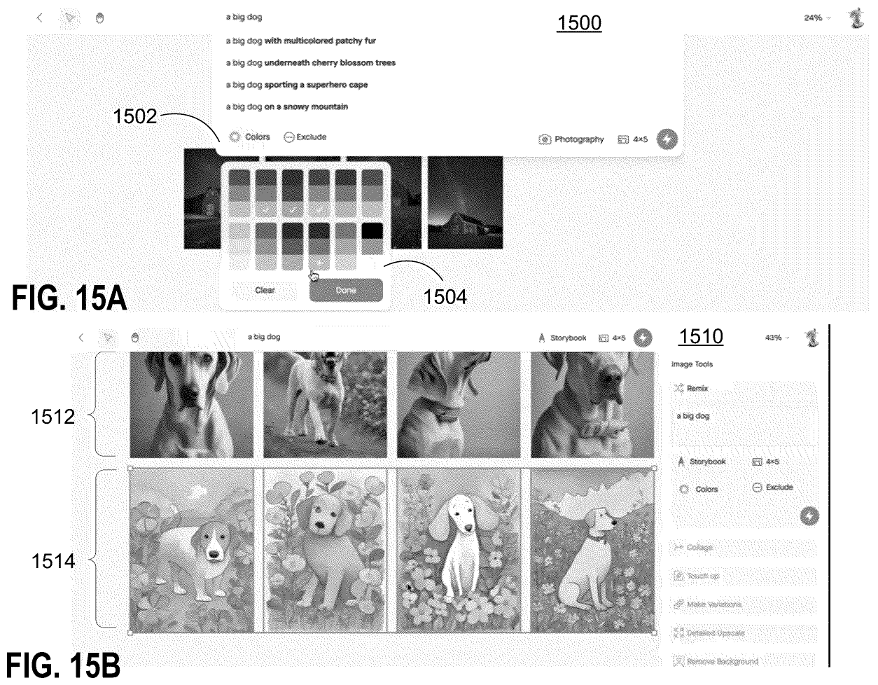

FIG. 15A depicts a text prompt interface with a color palette selection interface, according to one embodiment. In the embodiment of FIG. 15A, a user has entered a first text prompt within the text prompt entry user interface element of interface 1500 (e.g., the words “a big dog”). The interface 1500 includes a selectable interface element 1502 labeled “colors”. When the selectable interface element 1502 is selected during the entry of a text prompt, a color palette interface 1504 is displayed.

In the embodiment of FIG. 15A, the color palette interface 1504 includes 12 different color groups, each divided into three shades of the color corresponding to the color group. Each of the color shades within each color group is a selectable interface element, enabling a user to select one or more colors or shades of colors for use in generating a set of images. In the embodiment of FIG. 15A, a user has selected three color shades, each indicated by a checkmark. These shades include, from left to right, the lightest shade of pink, the lightest shade of purple, and the lightest shade of blue. Once the user has selected a set of colors, the user can initiate the creation of a set of images based on the selected set of colors (for instance, by selecting the “done” button illustrated in FIG. 15A, by completing the text prompt text entry, or by any other suitable means).

FIG. 15B depicts sets of images generated using the color palette selection interface of FIG. 15A, according to one embodiment. The interface 1510 includes a first set of generated images 1512 that corresponding to the text prompt “a big dog”, and a second set of generated images 1514 that corresponding to the text prompt “a big dog”, each generated using a different style (the first set of generated images 1512 is generated in a “photorealism” style, and the second set of generated images 1514 is generated using a “watercolor” style). In each set of generated images, the color palette of the images largely corresponds to the color shades selected in the embodiment of FIG. 15A. These images don't only include these colors, but prominently feature colors identical or similar to the selected colors. For instance, in some embodiments, at least a threshold percentage of the images or the primary subject matter or backgrounds or both of the images includes pixels within a threshold shade of the selected colors.

In practice, the generative design system 300 can include a color palette interface that includes any number of colors or color shades. Once a color is selected, information representative of the selected color (or colors) is provided to an image generation model, which can use the color information to generate one or more portions of the image to include the color. For instance, the image generation model can receive a numeric identifier corresponding to the color, chromatic information corresponding to the color, spectrum information corresponding to the color, and the like. In some embodiments, the image generation model can modify a generated image to include the selected colors, while in other embodiments, the image generation model can generate an image to include the selected colors from the outset of the image generation.

In some embodiments, the color palette interface can include a predetermined set of colors or color shades, while in other embodiments, the color palette interface can include a random selection of colors or color shades. In some embodiments, the colors or color shades within the color palette interface can be selected based on text within the text prompt interface. For instance, if the text prompt interface includes the text “a sunset”, the colors within the color palette interface can be selected based on common colors found in images of sunset. In some embodiments, the colors can be selected based on colors and color shades commonly found in the subject matter of the text prompt, based on colors and color shades that are not commonly found in the subject matter of the text prompt, or a based on a selection from both sets of colors and color shades.

In some embodiments, the colors and color shades within the color palette interface can be selected based on colors and color shades that have previously been selected by a user of the color palette interface or a set of other users of the color palette interface. For instance, a color palette interface may be populated with the 15 colors and color shades most often selected by a user. In some embodiments, the colors and color shades within the color palette interface may be selected based on other images generated within a user's canvas or work session. For instance, if a user has generated 20 images of various subject matter within a working session, then a color palette interface can be populated with the 25 colors and color shades most prominently used within the generated 20 images.

In some embodiments, the generative design system 300 can receive text descriptions of the selected colors as part of a text prompt. For instance, if a user selects the colors teal, beige, and magenta while entering the text prompt “a day at the beach”, then the text prompt can modified before the text prompt is provided to an image generation model to be “a day at the beach teal beige magenta”. In such embodiments, the names of the colors are selected to avoid including words that can unintentionally skew the text prompt, causing the image generation model to produce images with unintended subject matter. For instance, if a user selected the color “baby blue” for the text prompt “swimming pool”, modifying the text prompt to be “swimming pool baby blue” may cause the image generation model to generate images of a baby in a blue swimming pool as opposed to a swimming pool featuring the color baby blue. Accordingly, when a color is selected, words describing the color can be selected to exclude words that are also nouns, certain adjectives, certain verbs, or other blacklisted words. Accordingly, when the color “baby blue” is selected, the text prompt may instead be modified to include the words “light blue”.

In some embodiments, images can be generated using selected colors from text prompts (as noted above), which can be received directly from a user, which can be selected by a user, or which can be generated based on other content or images selected, viewed, or generated by the user. In other embodiments, an image itself can be used as an input by the generative design system 300 in conjunction with the color palette interface described herein. For instance, if during the course of generating, modifying, editing, and/or uploading images, a user selects an image, the user can then select a set of colors from the color palette interface, and the generative design system 300 can apply an image generation to the selected image and the selected set of colors, resulting in a set of images being generated that are similar to the selected image but that predominantly feature or include colors and color shades similar to the selected set of colors.

In some embodiments, the generative design system 300 can combine one or more images or portions of images to form a combined image, and can use the combined image as a seed image for an image generation model to generate a collage of additional images based on the combined image. For instance, a user may select a first portion of a first image, a second portion of a second image, and may superimpose the first portion and the second portion onto a third image.

In such an example, the resulting combined image may not be processed apart from simply overlaying the select portions onto the third image. As a result, the combined image may not include shadows corresponding to the selected portions of the first and second images, may have image artifacts or inconsistent color palettes, and the like. The image generation model can correct these inconsistencies when generating images using the combined image as a seed. For instance, the image generation model can include shadows corresponding to the selected portions of the first and second image, can remove image artifacts to smooth out lines and features in the images, can use a single color palette consistently throughout the images, and the like.

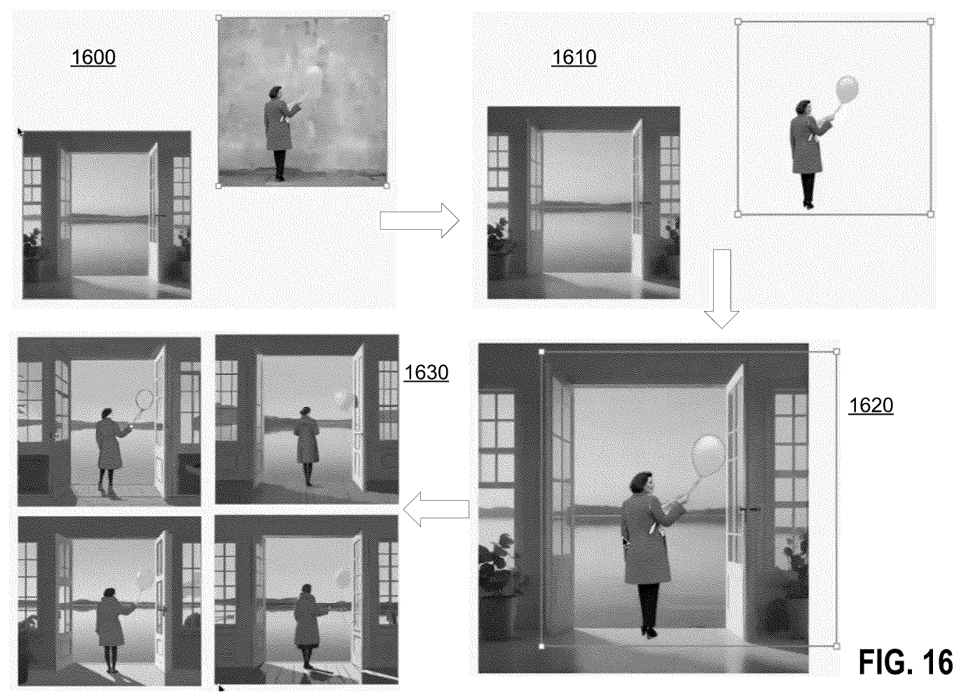

FIG. 16 depicts a process for combining images and generating an image collage based on the combined image, according to one embodiment. In the embodiment of FIG. 16, at step 1600, a first image of an open doorway overlooking a body of water and a second image of a woman holding a balloon are selected. At step 1610, a user performs a background removal operation on the second image, removing all portions of the second image other than the woman and the balloon. The first image has not been modified at step 1610.

At step 1620, a resizing operation is performed on the remaining portion of the second image to increase the size of the woman and the balloon. The resized remaining portion of the second image is then overlaid onto the first image, producing a combined image of a woman with a balloon standing in the open doorway of the first image. The combined image is provided to an image generation model at step 1630, which produces four variants of the combined image, each with differences from the combined image. In some embodiments, a user can specify a particular style of the produced images, resulting in images with similar subject matter and characteristics as the combined image, but with stylistic differences.

In some embodiments, one or more image processing operations can be performed on the combined image or on the images produced based on the combined image. In some embodiments, these image processing operations include preprocessing operations, performed on the combined image before the combined image is used by the generative design system 300 as a seed to generate additional images. For instance, a texture consistency operation can be performed on the combined image, so that the textures of the individual portions of the images used to create the combined image is consistent. Likewise, a color palette consistency operation can be performed such that the individual portions of the images used to create the combined image have a consistent color palette. In some embodiments, a smoothing operation can be performed such to reduce edges or other image artifacts that are created when the individual portions of the images used to create the combined image are combined.

In some embodiments, one or more image processing operations are performed on the images generated using the combined image as an input. For instance, a shadow generation operation can be performed to ensure that objects added to other images cast a shadow on portions of the other images. It should be noted that shadow generation operations can be performed on the combined image before being used to generate additional images. For example, if a person from a first image is added to a background of a second image to form a combined image, the combined image can be modified to include a shadow cast by the person onto the background within the combined image. Any image processing operations that can be performed on the combined image as a preprocessing operation can be performed on the images generated based on the combined image.

In some embodiments, images within the collage are generated to match a style of the combined image. For instance, the color palette and type of image of the generated images are similar to a color palette and type of image of the combined image. In some embodiments, the style and characteristics of each image in the collage are similar. In other embodiments, the style and characteristics of each image in the collage are different. For instance, a first image in a collage can be an oil painting representation of the combined image, a second image in the collage can be a photorealistic representation of the combined image, a third image in the collage can be a hand-drawn representation of the combined image, and a fourth image in the collage can be a steampunk CGI representation of the combined image.

The styles and characteristics of the generated images in the collage can be selected by the user, for instance via a displayed interface element. In some embodiments, the styles and characteristics of the generates images in the collage can be automatically selected, for instance based on other styles previously selected by the user in the generation of images (e.g., outside of the context of collage generation), based on styles of images within a user's current canvas or working session, or based on styles selected most commonly by other users. In some embodiments, the styles and characteristics of the generated images in the collage can be randomly selected from a list of image styles and characteristics.

As noted above, various embodiments of the generative design system 300 can include a set of moods (or styles) that can be applied by the generative design system 300 to create images with one or more characteristics corresponding to a selected mood. These moods can be manually created, for instance by a user of the generative design system 300. In some embodiments, the generative design system 300 can enable a mood to be automatically created based on a set of seed images selected by a user.

In such embodiments, the generative design system 300 identifies a set of characteristics shared by the set of seed images. For instance, the generative design system 300 can determine that the set of seed images have a similar subject matter or theme, have a similar color palette, have a similar setting, have a similar artistic style, or share any other characteristic, trait, or property (eg, the seed images share one or more “positive signals”). In some embodiments, the generative design system 300 can include one or more characteristics that the set of seed images do not have. For instance, the generative design system 300 can determine that none of the images have a particular subject matter, have a particular style, or have any other characteristic, trait, or property (eg, the seed images have one or more negative signals in common).

The generative design system 300 can generate an automatic mood creation interface, and can list out the positive and negative signals associated with the set of seed images. The generative design system 300 can also automatically generate a title for the mood based on subject matter or characteristics of the seed images. In addition, the generative design system 300 can generate one or more sample images corresponding to the automatically generate mood for display within the automatic mood creation interface.

Although the mood generation described herein is automated and may not require or use human input, in practice, a user may edit or adjust one or more characteristics of the generated mood. For instance, the user may include, adjust, or remove one or more positive or negative signals corresponding to the generated mood. Likewise, the user may adjust a title associated with the generated mood. Similarly, the user may remove, edit, adjust, or generative additional example images using the generative mood. Once the mood is finalize, a user may generate new images, for instance by providing a text prompt and selecting the generated mood when requesting the new images to be generated. The resulting generated images may include subject matter corresponding to the text prompt, and may be in the style corresponding to the generated mood.

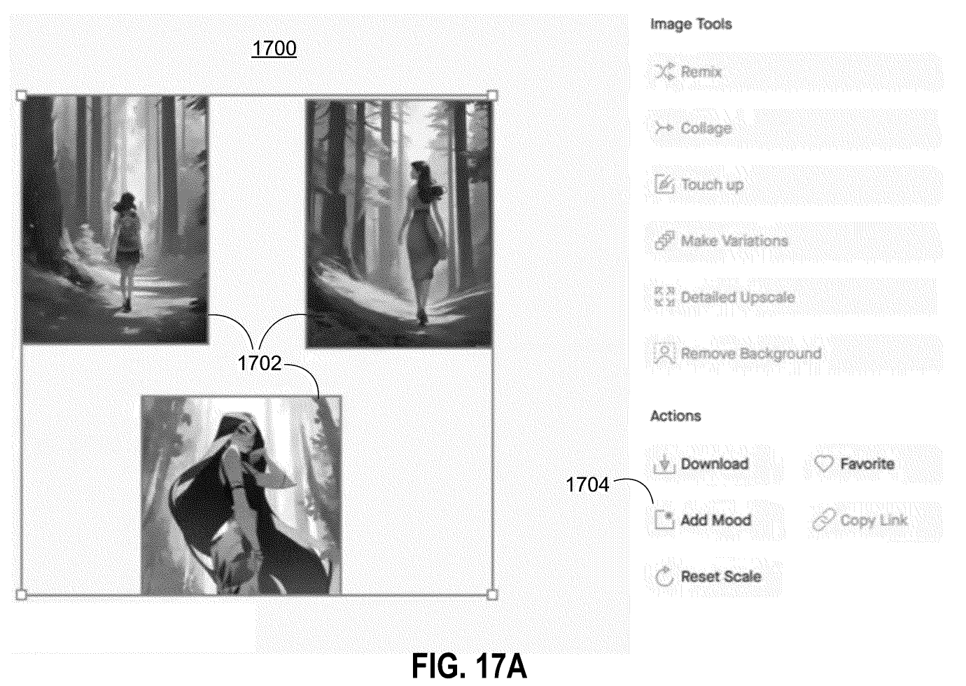

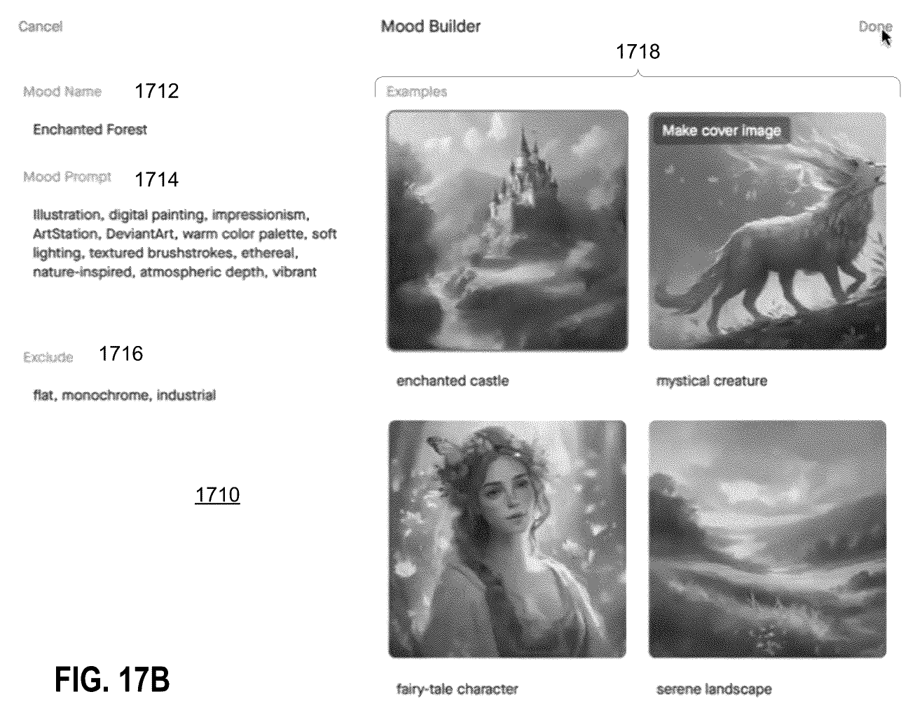

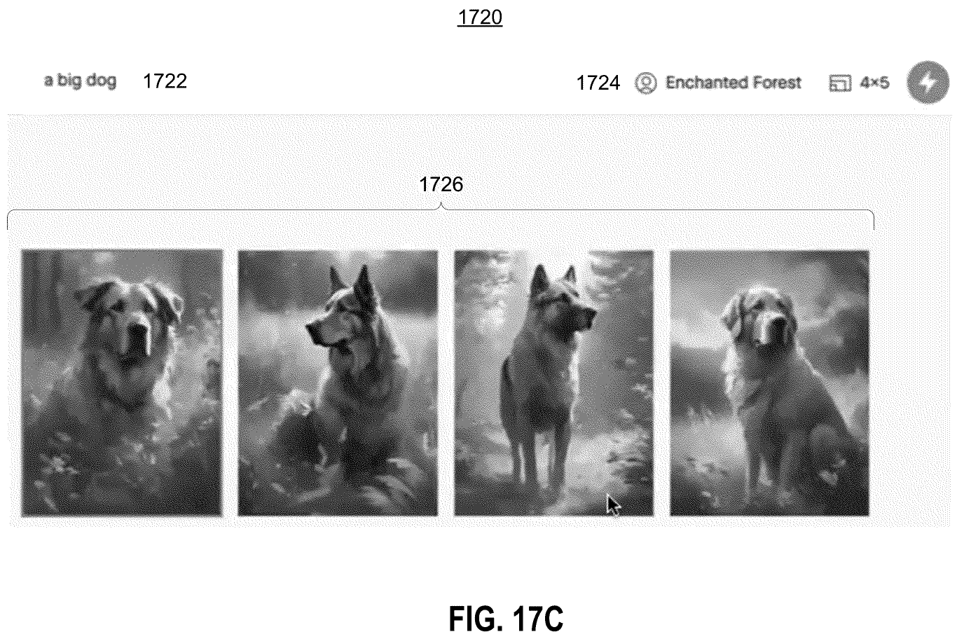

FIG. 17A depicts an interface for automatically creating a custom mood based on a set of seed images, according to one embodiment. In the embodiment of FIG. 17A, a user selects a set of seed images 1702 for use in generating a new mood using the interface 1700 of the generative design system 300. In the embodiment of FIG. 17A, the user has selected three images of a female in a forest. The user can choose to generate a mood based on these seed images using an interface element 1704 (labeled “add mood” in the embodiment of FIG. 17A). Once the user requests that the mood be generated, a mood generation interface is displayed to the user.

FIG. 17B depicts an interface illustrating characteristics and examples of the custom mood created using the interface of FIG. 17A, according to one embodiment. In the embodiment of FIG. 17B, the mood generation interface 1710 includes an example mood name or title 1712, a set of positive mood characteristics 1714, and a set of negative mood characteristics 1716. In the embodiment, of FIG. 17B, the mood title is “Enchanted Forest”, likely generated because of the forest setting of the seed images 1702.

The embodiment of FIG. 17B also includes a set of positive mood characteristics 1714 (“illustration”, “digital painting”, and so on) and a set of negative mood characteristics 1716 (“flat”, “monochrome”, and “industrial”). The positive characteristics can be determined if all or an above-threshold portion of the seed images have a characteristic in common. Likewise, the negative characteristics can be determined if none or a below-threshold portion of the seed images do not have a particular characteristic. The interface 1710 likewise includes a set of example images 1718 generated based on the positive mood characteristics 1714, the negative mood characteristics 1716, and the subject matter represented by the title 1712. Each example image likewise includes a text description describing the subject matter of the example image. Once a user approves of the generated mood, the user may use the generated mood to generate additional images, for instance based on a text prompt.

FIG. 17C depicts an interface illustrating a set of images generated using a text prompt and the mood created in the embodiment of FIG. 17B. In the embodiment of FIG. 17C, a user has entered the text prompt “a big dog” 1722 within the interface 1720, and has requested that images be generated using the generated mood 1724, generated in the embodiments of FIGS. 17A and 17B. The set of generated images 1726 each include the subject matter of the text prompt (“a big dog”) and each include many of the positive characteristics 1714 of the generated mood without including many (or any) of the negative characteristics 1716 of the generated mood.

### ADDITIONAL CONSIDERATIONS

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements that are not in direct contact with each other, but yet still co-operate or interact with each other.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Furthermore, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for the described embodiments as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the scope defined in the appended claims.

What is claimed is:

1. A method comprising:
accessing, by an image generation system, a generative image text prompt based on an input from a user;
displaying, within a palette interface of the image generation system, a set of color interface elements each corresponding to a different color;
receiving, from the user, a selection of a subset of the color interface elements;
applying, by the image generation system, a generative image model to the generative image text prompt and to a set of colors corresponding to the subset of the color interface elements to generate a set of images that each predominantly feature the set of colors; and
displaying, by the image generation system, the generated set of images within a digital canvas to the user.

2. The method of claim 1, wherein each image of the set of images includes an above-threshold percentage of pixels within the image that include the set of colors or colors within a threshold similarity to one or more colors of the set of colors.

3. The method of claim 1, wherein each image of the set of images includes a different visual style.

4. The method of claim 1, wherein the colors corresponding to the set of color interface elements are selected based on a subject matter associated with the generative image text prompt.

5. The method of claim 1, wherein the colors corresponding to the set of color interface elements are selected based on colors used by the user in other images generated by the user within the digital canvas.

6. The method of claim 1, wherein the generative image text prompt is entered by the user into a text prompt interface element.

7. The method of claim 1, wherein the generative image text prompt is determined based on one or more images selected or created by the user.

8. A non-transitory computer-readable storage medium storing executable instructions that, when executed by a hardware processor, cause the hardware processor to perform steps comprising:
accessing, by an image generation system, a generative image text prompt based on an input from a user;
displaying, within a palette interface of the image generation system, a set of color interface elements each corresponding to a different color;
receiving, from the user, a selection of a subset of the color interface elements;
applying, by the image generation system, a generative image model to the generative image text prompt and to a set of colors corresponding to the subset of the color interface elements to generate a set of images that each predominantly feature the set of colors; and
displaying, by the image generation system, the generated set of images within a digital canvas to the user.

9. The non-transitory computer-readable storage medium of claim 8, wherein each image of the set of images includes an above-threshold percentage of pixels within the image that include the set of colors or colors within a threshold similarity to one or more colors of the set of colors.

10. The non-transitory computer-readable storage medium of claim 8, wherein each image of the set of images includes a different visual style.

11. The non-transitory computer-readable storage medium of claim 8, wherein the colors corresponding to the set of color interface elements are selected based on a subject matter associated with the generative image text prompt.

12. The non-transitory computer-readable storage medium of claim 8, wherein the colors corresponding to the set of color interface elements are selected based on colors used by the user in other images generated by the user within the digital canvas.

13. The non-transitory computer-readable storage medium of claim 8, wherein the generative image text prompt is entered by the user into a text prompt interface element.

14. The non-transitory computer-readable storage medium of claim 8, wherein the generative image text prompt is determined based on one or more images selected or created by the user.

15. A system comprising:
a hardware processor; and
a non-transitory computer-readable storage medium storing executable instructions that, when executed by the hardware processor, cause the hardware processor to perform steps comprising:
accessing, by an image generation system, a generative image text prompt based on an input from a user;
displaying, within a palette interface of the image generation system, a set of color interface elements each corresponding to a different color;
receiving, from the user, a selection of a subset of the color interface elements;
applying, by the image generation system, a generative image model to the generative image text prompt and to a set of colors corresponding to the subset of the color interface elements to generate a set of images that each predominantly feature the set of colors; and
displaying, by the image generation system, the generated set of images within a digital canvas to the user.

16. The system of claim 15, wherein each image of the set of images includes an above-threshold percentage of pixels within the image that include the set of colors or colors within a threshold similarity to one or more colors of the set of colors.

17. The system of claim 15, wherein each image of the set of images includes a different visual style.

18. The system of claim 15, wherein the colors corresponding to the set of color interface elements are selected based on a subject matter associated with the generative image text prompt.

19. The system of claim 15, wherein the colors corresponding to the set of color interface elements are selected based on colors used by the user in other images generated by the user within the digital canvas.

20. The system of claim 15, wherein the generative image text prompt is entered by the user into a text prompt interface element or is determined based on one or more images selected or created by the user.
